(19) United States
(12) Patent Application Publication
(10) Pub. No.: US 2010/0189939 A1
(43) Pub. Date: Jul. 29, 2010

(54) FIBER REINFORCED ARTICLE AND METHOD OF MAKING SAME

(76) Inventor: Yeon Kim, Seoul (KR)

Correspondence Address: HYUN JONG PARK;Park & Associates IP Law LLC, 265 Bic Drive, Suite 106, Milford, CT, 06461, US

(21) Appl. No.: 12/361,462

(22) Filed: Jan. 28, 2009

(51) Int. Cl. B32B 1/08; B29C 65/52

(52) U.S. Cl. 428/35.8; 156/276

(57) ABSTRACT

A structural element reinforced with composite materials comprises: a core part in a shape of an article and with sharp edges or corners rounded off, the core part having a first external surface forming about one half of an entire external surface of the article, the core part further having a second external surface forming about the other half of the entire external surface of the article; a first reinforcing cloth adhered on the first external surface of the core part, the first reinforcing cloth containing resin and reinforcing particles or fibrous materials; and a second reinforcing cloth adhered on the second external surface of the core part, the second reinforcing cloth containing resin and reinforcing particles or fibrous materials. A method of producing the structural element is also disclosed, in which the external surface of the structural element is divided into two surfaces (i.e., first and second external surfaces), and a reinforcing fiber cloth are securely attached on each external surface one after another, by application of vacuum pressure on a resilient backing film covering a reinforcing cloth for attaching.

### FIELD OF THE INVENTION

The present invention relates to an article or a structural component, for example, such as an archery bow component, which is reinforced with composite materials such as carbon fibers and fibrous reinforcing materials of fabric type, and also to a method for reinforcing such a structural member or article with fibrous reinforcing materials.

### BACKGROUND OF THE INVENTION

Composite materials have been introduced in the industry to provide various functions and characteristics to articles or structural members, for example, to provide enhanced strength and durability to the articles. Composite materials, such as carbon fibers, are typically formed of two categories of constituent materials, namely, matrix (typically formed of resin) and reinforcements, for example, such as carbon fibers, fiberglass, and Kevlar, etc. For example, carbon fiber reinforced plastics have many applications in many industrial fields such as aerospace and sporting good fields.

One typical method of producing carbon fiber reinforced plastics is by layering sheets of carbon fiber cloth into a mold in the shape of the final product. The mold is then filled with polymer or resin, such as epoxy, and is cured. The resulting part is very strong for its weight. However, this conventional method requires a high manufacturing cost primarily due to the high manufacturing cost of the mold of precise configuration and the complex quality control measures required in the manufacturing processes.

As another example, one prior art method of producing a carbon fiber reinforced article, in particular, a bow limb, is disclosed in U.S. Pat. No. 5,657,739. This method also utilizes a mold of precise mold pattern to layer carbon fibers on one surface of the limb, and also requires complex quality control measures, thus, resulting in a reduced production rate and increased manufacturing costs.

### SUMMARY OF THE INVENTION

Accordingly, in view of the above mentioned drawbacks in the conventional method of composite material reinforced plastics, the present invention is directed to a method of reinforcing articles or structural members with reinforcing materials without utilizing such an expensive mold and requiring precise quality control procedures in the molding processes. The present invention is also directed to a composite material reinforced article, for example, such as a reinforced archery components (e.g., a bow handle or riser, a bow limb, or other structural components of archery products), produced by the inventive method as disclosed in this disclosure. Thus, according to the present invention, a composite material reinforced article can be produced without utilizing a mold to form the reinforcement structures onto the articles, which requires a high equipment cost and complex quality control procedures. Thus, the present invention provides a useful method of producing composite material reinforced articles, which is reliable and also capable of reducing a manufacturing cost, such as the mold cost, in producing the articles.

According to one aspect of the invention, a method for reinforcing an article comprises the steps of: (a) providing a core part preformed in a shape of the article, the core part having a first external surface and a second external surface; (b) applying adhesive on the first external surface of the core part; (c) placing a first reinforcing cloth (for example, prepreg carbon fiber fabric) over the first external surface of the core part in such a manner that the reinforcing cloth is evenly distributed and conforms to the first external surface of the core part, the first reinforcing cloth containing resin and reinforcing particles or fibrous materials and having a size to cover the first external surface of the core part; (d) placing a first synthetic film of flexible and expandable property over the first reinforcing cloth, the first synthetic film having a size to cover an entire surface of the first reinforcing cloth; (e) hermetically sealing a circumferential area of the first synthetic film to prevent air from passing through the circumferential area of the first synthetic film; (f) applying a vacuum pressure onto the core part covered with the first reinforcing cloth and the first synthetic film, and causing the first reinforcing cloth and the first synthetic film to closely contact and adhere to the first external surface of the core part; (g) peeling off the first synthetic film and removing a circumferential non-adhered portion of the first reinforcing cloth from the core part; (h) applying adhesive on the second external surface of the core part; (i) placing a second reinforcing cloth over the second external surface of the core part in such a manner that the reinforcing cloth is evenly distributed and conforms to the second external surface of the core part, the second reinforcing cloth containing resin and reinforcing particles or fibrous materials and having a size to cover the second external surface of the core part; (j) placing a second synthetic film of flexible and expandable property over the second reinforcing cloth, the second synthetic film having a size to cover an entire surface of the second reinforcing cloth; (k) hermetically sealing a circumferential area of the second synthetic film to prevent air from passing through the circumferential area of the second synthetic film; (l) applying a vacuum pressure onto the core part covered with the second reinforcing cloth and the second synthetic film, and causing the second reinforcing cloth and the second synthetic film to closely contact and adhere to the second external surface of the core part; and (m) peeling off the second synthetic film and removing a circumferential non-adhered portion of the second reinforcing cloth from the core part.

In one preferred embodiment of the invention, the method further comprises the steps of: curing the adhesive, preferably under a heated condition, each step performed after the respective step (f) and (l) of applying the vacuum pressure onto the core part and causing the respective reinforcing cloth and synthetic film to adhere to the core part. In another preferred embodiment of the invention, the reinforcing clothes contain resin as matrix material and one or more reinforcing particles or fibrous materials selected from a group consisting of carbon fiber, fiberglass, Kevlar or aramid fiber, boron, titanium, stainless, aluminum, and steel. In another preferred embodiment of the invention, the reinforcing clothes have multiple layers with different weave patterns or different layering orientations to improve a mechanical strength or performance of the resultant article. In another preferred embodiment of the invention, the synthetic films are materials selected from polypropylene, BOPP (biaxially oriented polypropylene), teflon, urethane, polyethylene.

According to another aspect of the invention, an article reinforced with composite materials comprises: a core part in a shape of an article and with sharp edges or corners rounded off, the core part having a first external surface forming about one half of an entire external surface of the article, the core part further having a second external surface forming about the other half of the entire external surface of the article; a first reinforcing cloth adhered on the first external surface of the core part, the first reinforcing cloth containing resin and reinforcing particles or fibrous materials; and a second reinforcing cloth adhered on the second external surface of the core part, the second reinforcing cloth containing resin and reinforcing particles or fibrous materials.

In one preferred embodiment, the reinforcing particles or fibrous materials contained in the first and second reinforcing clothes are selected from a group consisting of carbon fiber, fiberglass, Kevlar or aramid fiber, boron, titanium, stainless, aluminum, steel, and other reinforcement materials known in the composite material industry. In another preferred embodiment, the first reinforcing cloth is adapted to have an adhesive property, and is adhered on the first external surface of the core part by covering a first synthetic film of flexible and expandable property over the first reinforcing cloth and then applying a vacuum pressure onto the covered core part, and wherein the second reinforcing cloth is adapted to have an adhesive property, and is adhered on the second external surface of the core part by covering a second synthetic film of flexible and expandable property over the second reinforcing cloth and then applying a vacuum pressure onto the covered core part.

According to a further aspect of the invention, a method of making a component of an archery bow comprises the steps of: (a) producing a core part in a shape of an archery bow component having a generally circular, oval, rectangular, or polygonal cross section with sharp edges or corners rounded off, the core part having a first or upper face surface, a second or lower face surface corresponding to the first or upper face surface, a first lateral surface, and a second lateral surface corresponding to the first lateral surface; (b) applying adhesive on a first external surface of the core part, the first external surface covering the first or upper face surface and from about a third of the first and second lateral surfaces at an upper side of the lateral surfaces to about all of the first and second lateral surfaces; (c) placing a first reinforcing cloth over the first external surface of the core part in such a manner that the reinforcing cloth is evenly distributed and conforms to the first external surface of the core part, the first reinforcing cloth containing resin and reinforcing particles or fibrous materials and having a size to cover the first external surface of the core part; (d) placing a first synthetic film of flexible and expandable property over the first reinforcing cloth, the first synthetic film having a size to cover an entire surface of the first reinforcing cloth; (e) hermetically sealing a circumferential area of the first synthetic film to prevent air from passing through the circumferential area of the first synthetic film; (f) applying a vacuum pressure onto the core part covered with the first reinforcing cloth and the first synthetic film, and causing the first reinforcing cloth and the first synthetic film to closely contact and adhere to the first external surface of the core part and also to remove air bubbles entrapped or retained between the core part and the first reinforcing cloth; (g) curing the adhesive applied on the first external surface of the core part under a heated condition, and thus causing the first reinforcing cloth to firmly adhere to the core part; (h) peeling off the first synthetic film and removing a residual or unnecessary portion of the first reinforcing cloth from the core part; (i) applying adhesive on a second external surface of the core part, the second external surface covering the second or lower face surface and from about none of the first and second lateral surfaces to about two thirds of the first and second lateral surfaces at a lower side of the lateral surfaces; (j) placing a second reinforcing cloth over the second external surface of the core part in such a manner that the reinforcing cloth is evenly distributed and conforms to the second external surface of the core part, the second reinforcing cloth containing resin and reinforcing particles or fibrous materials and having a size to cover the second external surface of the core part; (k) placing a second synthetic film of flexible and expandable property over the second reinforcing cloth, the second synthetic film having a size to cover an entire surface of the second reinforcing cloth; (l) hermetically sealing a circumferential area of the second synthetic film to prevent air from passing through the circumferential area of the second synthetic film; (m) applying a vacuum pressure onto the core part covered with the second reinforcing cloth and the second synthetic film, and causing the second reinforcing cloth and the second synthetic film to closely contact and adhere to the second external surface of the core part and also to remove air bubbles entrapped or retained between the core part and the second reinforcing cloth; (n) curing the adhesive applied on the second external surface of the core part under a heated condition, and thus causing the second reinforcing cloth to firmly adhere to the core part; and (o) peeling off the second synthetic film and removing a residual or unnecessary portion of the second reinforcing cloth from the core part.

### BRIEF DESCRIPTION OF THE DRAWINGS

The above described and other objects, features and advantages of the present invention will be more apparent from the presently preferred embodiments of the invention disclosed in the following description and illustrated in the accompanying drawings, in which:

FIG. 1 is a perspective view illustrating one exemplary article of generally rectangular cross section, constructed according to the concepts and principles of the present invention;

FIG. 2 is a perspective view illustrating another exemplary article of generally circular or oval cross section, constructed according to the concepts and principles of the present invention;

FIG. 3 is a perspective view illustrating another example of an article, namely a bow handle or riser, constructed according to one embodiment of the present invention;

FIGS. 4(A)-4(C) are views illustrating examples of fiber reinforced clothes usable in the reinforcing methods and articles thereof according to the present invention;

FIGS. 5(A) and (B) are cross-sectional views illustrating an exemplary structure of the reinforced article, constructed according to the principles of the present invention;

FIG. 6 is an elevation view showing one example of an archery bow having a bow handle (riser) and two limbs coupled to the handle;

FIG. 7 is a perspective view illustrating one example of the article receptacle of the present invention to receive the preformed article therein and to perform the fiber cloth application processes of the invention;

FIG. 8 is a perspective view illustrating a state in which the bow handle (riser) is placed within a lower portion of the receptacle;

FIG. 9 is a perspective view illustrating a state in which the fiber cloth and the resilient polymer film are covered over the bow handle core part prior to applying a vacuum pressure, and further showing that the polymer film in turn hermetically engaged between the upper cover part and the lower receptacle part of the article receptacle; and

FIG. 10 is a photographic view illustrating one example showing a state of the bow handle in which a composite material or fiber cloth is securely adhered to a front face and a substantial portion of lateral sides of the bow handle by application of the vacuum pressure.

### DETAILED DESCRIPTION OF THE INVENTION

As summarized above, the present invention is directed to an article, which is reinforced with composite materials such as carbon fibers and fibrous reinforcing material, and also to a method for reinforcing such an article with fibrous reinforcing materials. The following disclosure describes and illustrates the present invention in connection primarily with constructing an archery component, particularly, a bow handle and/or limb (as described in U.S. Pat. No. 5,657,739). However, the present invention is not limited to an archery component, and other articles or products of various shapes and dimensions, and methods of producing them, recognizable based on the principles and concepts of the present invention as summarized by the claims appended in this application, are also within the scope of the invention.

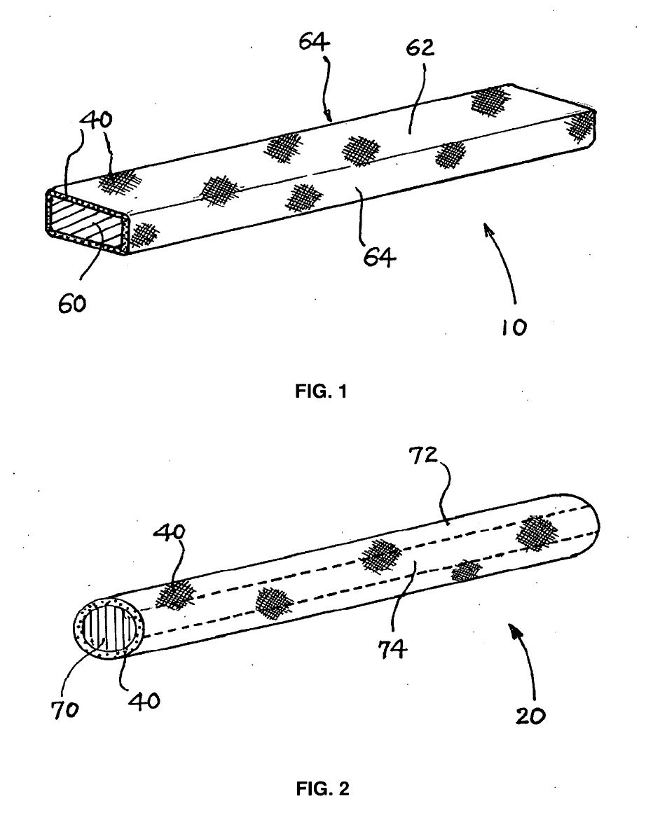

As such, the present invention can be applicable to a wide variety of articles, and producing methods thereof. For example, with reference to FIGS. 1 and 2, the articles can have various cross sectional shapes, such as generally a rectangular shape (FIG. 1 ), a circular or oval cross shape (FIG. 2), a triangular or polygonal shape (not shown), and various other shapes (not shown).

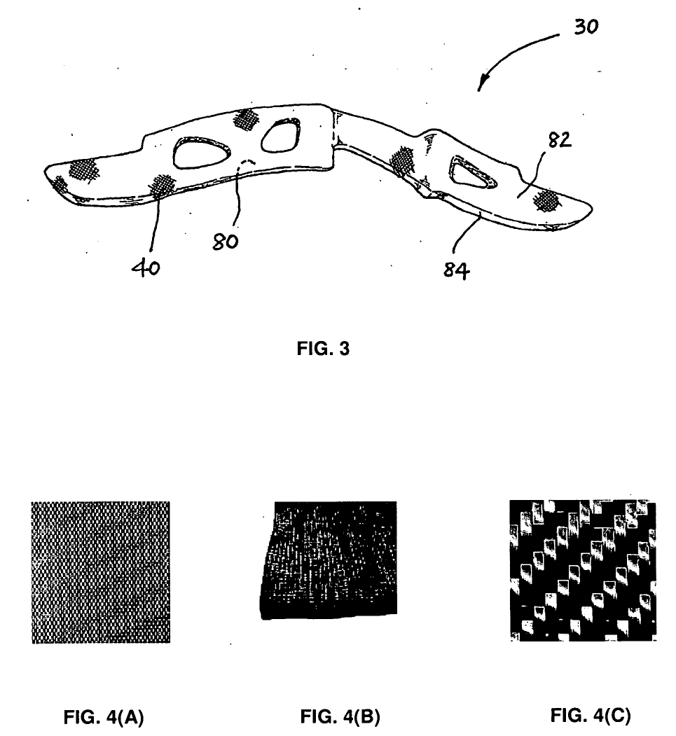

FIG. 3 illustrates an example of an article, namely a bow handle or riser, which is constructed according to one embodiment of the present invention.

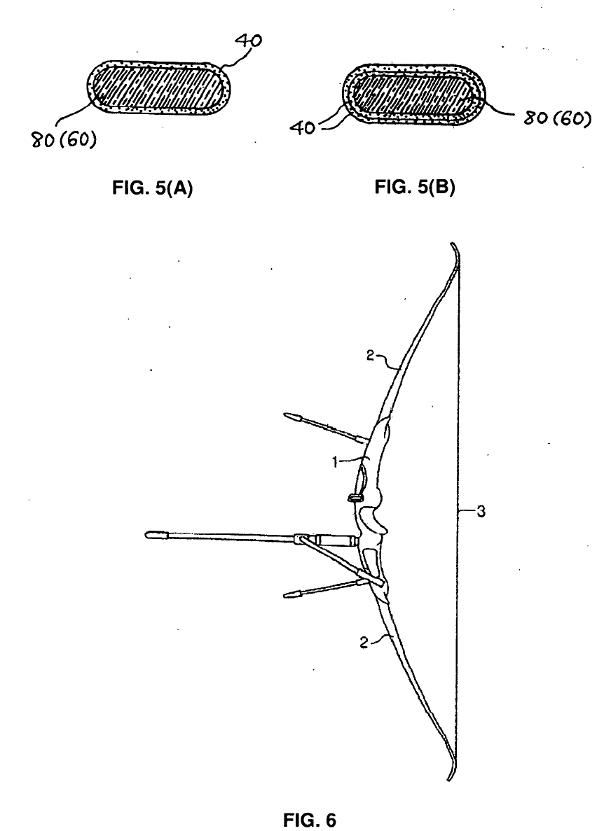

Referring to FIGS. 1-3, the articles 10, 20, and 30 include a composite material 40 securely adhered to a substantially entire external surface of the article. The composite material 40 is formed preferably in one or more sheets of fabric or weaved clothes having a resilient or flexible property. More preferably, the composite material 40 is a reinforcing cloth or fabric, preferably formed with prepreg layer(s), which contains resin (as matrix material) and one or more reinforcing particles or fibrous materials selected from a group consisting of carbon fiber, fiberglass, Kevlar or aramid fibers, boron, titanium, stainless, aluminum, steel, and other reinforcement materials known in the material industry. One pertinent candidate of the composite material 40 is carbon fiber, typically formed or woven in a pattern, such as plain weave pattern (see FIG. 4(A)), unidirectional pattern (FIG. 4(B)), twill weave pattern (FIG. 4(C)), and various other or complex patterns known in the carbon fiber or composite material field. The reinforcing fabric can be in one layer (see FIG. 5(A)) or multiple layers (see FIG. 5(B)) with different weave patterns or different layering orientations to improve a mechanical strength and performance (such as shock absorbent and twist-resistant characteristics) of the resultant article. When applying to a bow handle or limb subjecting to high and repetitive tensile stresses, the reinforcing fabric is preferably of multiple layers combined or woven with different weave patterns or different layering alignments to provide the required tensile and twist resistant property. A wide variety of carbon fibers or other composite materials are available from various sources. For example, carbon fibers are available from the sources known as Mitsubishi Rayon, Toray, Hexcel, and Grafil.

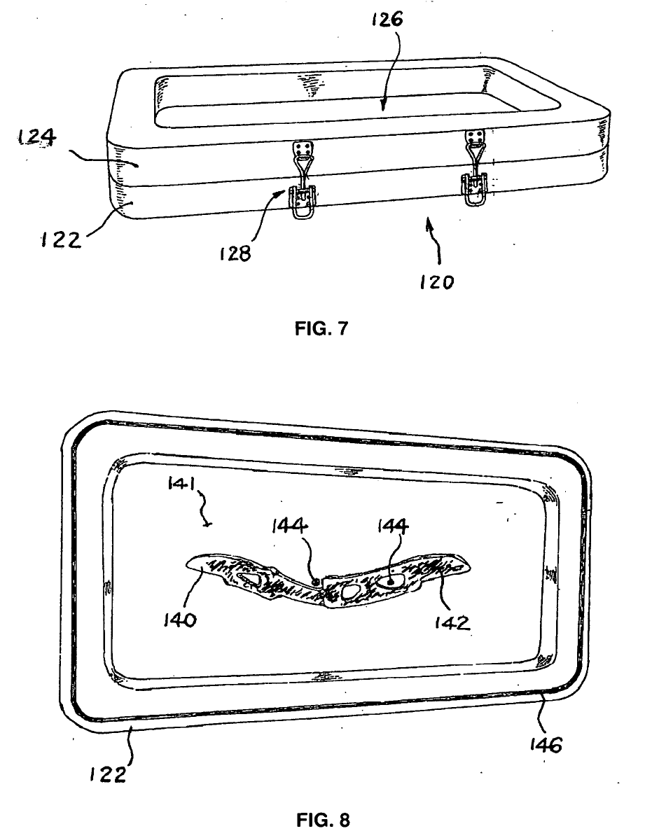

With reference to FIGS. 7-10, presently preferable methods of producing the reinforced article are described below in details and in connection primarily with constructing a bow handle of an archery bow, only as one example to describe the present invention. FIG. 6 illustrates one sample of an archery bow, showing a handle or riser 1, two limbs 2 attached to the handle 1, and a string 3 attached to the free ends of the limbs 2.

As an initial step, a core part (such as 60, 70, 80 in FIGS. 1-3) is produced in a shape resembling a final product of the article to be made, or otherwise, a core part preformed in a shape of the article is provided, for example, from a vender, the manufacture itself, or others. The core part can be made of plastic material, aluminum, steel, wood, or composite material. According to one preferred embodiment of the invention as applied to the bow handle or limb, the core part 80 is made of urethane, urea, epoxy, or aluminum, such as aluminum known as 6061 and 7075 series. In another preferred embodiment, the core part 80 is made of a plastic or polymer material, for example, urethane or urea, with metallic or ceramic fillers and/or reinforcing metallic inserts incorporated therein.

In order to adequately cover by evenly distributing a fabric type composite material onto the surface of the core part in a subsequent step (to be described below in details), it is preferable to produce the core part (such as the bow handle 30) with sharp or protruded edges, tips and corners of the core part rounded off or removed to some extent as long as such sharp edges or corners are not critical in the intended function and design of the article. Moreover, in order to make the covered fiber fabric (which is in turn covered with a resilient synthetic film) properly conform to the external surface of the core part and cause to securely adhere thereon in a subsequent vacuum application step (to be described below in details), it is also desirable to produce the core part in a shape suitable for the vacuum pressure application on the external surface of the core part and also suitable for the covered reinforced fabric to conform to the surface of the core part. Thus, these should be considered as a design factor for the articles.

Next, an adhesive is applied on a first external surface of the core part. In this application, the first external surface is intended to refer as both a first or upper surface (such as surface 62, 72, or 82 in FIGS. 1-3) and a substantial portion of lateral or side surfaces (such as surface 64, 74, or 84). Here, when the article has a continuous cross section as shown in FIG. 2, the side surface (such as 74) is arbitrarily defined by the manufacturer by an imaginary line (dotted line in FIG. 2) to define the adhesive covering range on the core part. Preferably, the first external surface include, in addition to the upper surface, from about one third (from the top) or to the entire surface of the two opposingly-disposed lateral or side surfaces.

According to one preferred embodiment of the invention as applied to the bow handle or limb, the first external surface includes the upper face surface 82 and from about a third (which is measured from the upper surface of the lateral surface) of the first and second lateral surfaces 84 to about all of the two opposing lateral surfaces 84.

The adhesive can be selected from a variety of adhesive materials applicable and known to securely attach the composite material 40 onto the core part 60, 70, or 80. According to one preferred embodiment, the adhesive is epoxy resin in liquid form and partially dried in a state not to readily adhere or stick onto a hand of the applicator. This can facilitate the fiber application process by the applicator. As will be described later, the partially dried adhesive is subject to a curing process in a subsequent process to have the composite material 40 firmly adhered on the eternal surface of the core part.

Next, a reinforcing cloth of composite material (described above) is sized to cover the entire first external surface of the core part, and is placed over the first external surface on which the adhesive was applied in the previous process. This placed reinforcing cloth is then expanded smoothly over the surface of the core part by hand or with a suitable tool in such a manner that the reinforcing cloth is evenly and smoothly distributed and conforms to the first external surface of the core part. As described above, the reinforcing cloth contains resin (as matrix) and reinforcing particles or fibrous materials, preferably formed in thin prepreg layer(s). As mentioned above, as the core part is preferably configured to have a shape of the article with sharp or protruded edges, tips and corners rounded off or removed, the applicator can distribute the reinforcing fabric evenly and smoothly over the core part. Having the previously applied adhesive of the partially sticky condition, the placed reinforcing cloth can adhere easily (but not firmly affixed) onto the surface of the core part.

It is noted that the above described method step of placing and covering the reinforcing fiber cloth over the surface of the core part and its subsequent steps (to be described below) can be performed with the core part placed in a specially designed container or receptacle to facilitate the processes. One preferable example of the receptacle and its usage will be described later in details in connection with FIGS. 7-9.

Next, a synthetic sealing film of flexible, expandable, and air-impermeable property is sized to cover the entire surface of the reinforcing cloth, and placed over the reinforcing cloth which was adhered on the first external surface of the core part. The synthetic films are formed of materials selected from polypropylene, BOPP (biaxially oriented polypropylene), teflon, urethane, and polyethylene. However, other resilient thin polymeric or rubber materials can also be usable as long as they are suitable for the intended purposes as described in this application. The synthetic film is formed to have a thickness preferably in a range from about 0.02 mm to about 0.2 mm, which can be varied depending upon the particular film used and the specification and thickness of the underlying reinforcing clothNext, a circumferential area of the synthetic film (outside areas from the placed reinforcing cloth) is hermetically sealed to prevent air from passing through the circumferential area of the synthetic film. This airtight sealing can facilitate the subsequent vacuum pressure application process (to be described below) and causes to have the respective reinforcing cloth closely adhered to the core part while removing air bubbles entrapped or retained between the core part, adhesive, and reinforcing cloth.

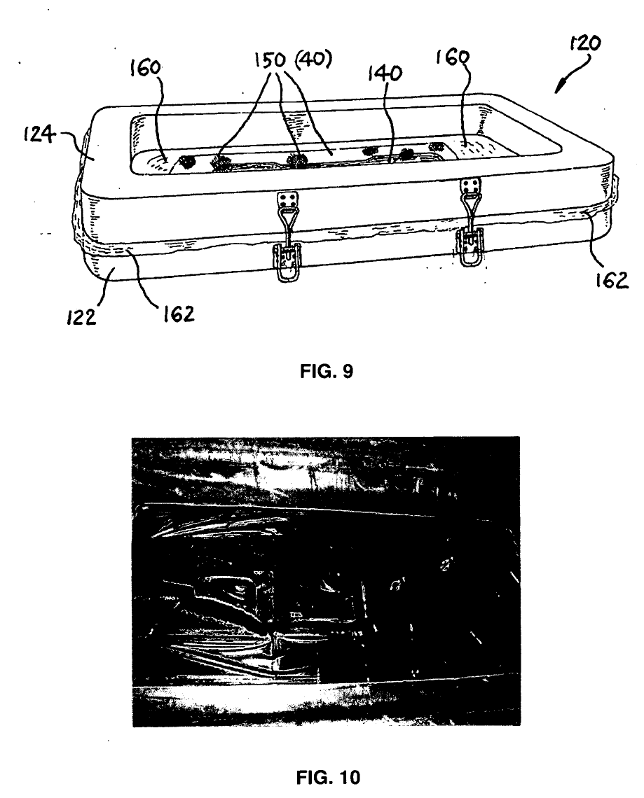

As will be described below, FIG. 9 illustrates one exemplary method and tooling facilitating the hermetical sealing of the synthetic film.

Now, a vacuum pressure is applied onto the core part covered with the reinforcing cloth and the synthetic film, which causes the reinforcing cloth and the resilient synthetic film to securely contact and adhere to the first external surface of the core part where the adhesive was applied, while also removing air bubbles retained or entrapped between the core part, adhesive, and reinforcing cloth. In one preferable embodiment, this process is performed with the material-covered core part installed in a specially designed tool, such as receptacle 120, as will be described below.

Next, the adhesive is cured to cause the reinforcing cloth to securely and firmly adhere to the core part. The curing process can be performed under either a room temperature condition or in a heated environment of a temperature ranging up to 200 or 300° C., more preferably of a range from about 100° C. to about 150° C. This curing temperature depends primarily upon the material and addictives contained in the adhesive.

Now, the synthetic sealing film is peeled off from the reinforcing cloth, and a residual or unnecessary portion of the first reinforcing cloth (such as the non-adhered region outside of the first external surface where the adhesive was not applied) is cut and removed from the core part. This typically completes a first part of the inventive method, namely, the fiber fabric application process on the previously-defined first external surface of the core part.

Now, the above-described steps (namely, from the step of applying adhesive to the step of peeling off synthetic film and removing residual fiber cloth) are repeated to provide the reinforcement on the second external surface of the core part, which surface is typically the remaining surface oppositely disposed from the first external surface.

The following represents a summary of the reinforcing processes applying to the second external surface of the core part. However, the details of such processes should be referred to the above described in connection with the first external surface of the core part because they are basically the same or similar.

(A) Applying adhesive on the second external surface of the core part;

(B) Placing a second reinforcing cloth over the second external surface of the core part in such a manner that the reinforcing cloth is evenly distributed and conforms to the second external surface of the core part, the second reinforcing cloth containing resin and reinforcing particles or fibrous materials and having a size to cover the second external surface of the core part;

(C) Placing a second synthetic film of flexible and expandable property over the second reinforcing cloth, the second synthetic film having a size to cover an entire surface of the second reinforcing cloth;

(D) Hermetically sealing a circumferential area of the second synthetic film to prevent air from passing through the circumferential area of the second synthetic film;

(E) Applying a vacuum pressure onto the core part covered with the second reinforcing cloth and the second synthetic film, and causing the second reinforcing cloth and the second synthetic film to closely contact and adhere to the second external surface of the core part and also to remove air bubbles entrapped or retained between the core part and the second reinforcing cloth;

(F) Curing the adhesive applied on the second external surface of the core part under a room temperature or heated condition, and thus causing the second reinforcing cloth to firmly adhere to the core part; and

(G) Peeling off the second synthetic film and removing a residual or unnecessary portion of the second reinforcing cloth from the core part.

### Application Example:

According to one preferable embodiment of the present invention, a specially designed tool, namely, an article receptacle is provide to place the preformed article therein and thereafter performing the above described method steps of the invention in an effective manner.

FIG. 7 illustrates one exemplary receptacle 120. The receptacle 120 includes a lower receptacle member 122 which is coupled with a cover or upper lid member 124 in a detachable, openable, or accessible manner. The lower receptacle member 122 defines a receptacle space for receiving a core part therein to perform the processes of the invention as described. The lid member 124 include a through opening (such as a central cavity 126) to enable the external air to freely communicate with the interior space of the lower receptacle member 122. Coupling members 128 are provided to securely fasten and lock the upper and lower receptacle members 122 and 124 together.

FIG. 8 illustrates the inner area of the lower receptacle member 122 in detail, with a core part (i.e., bow handle 140) placed in the receptacle area 141 after applying adhesive 142 on a first external surface (i.e., upper face and a substantial portion of side surfaces) as described above. As shown in FIG. 8, the lower receptacle member 122 includes one or more suction hole 144 located at suitable locations for applying the vacuum pressure onto the core part. A suction pipe is connected to the suction hole 144, is also connected a vacuum pump (not shown) for applying the vacuum pressure, thus, forcing the fiber cloth to closely adhere to the core part. An airtight seal 146 (such as rubber or silicon seal) is provided at the circumference of the lower receptacle member 122 and upper lid 124, respectively, at a corresponding location, and thus, enabling an hermetical sealing of the receptacle 120 when it is closed and locked by the coupling fastener 128.

FIG. 9 illustrates a state in which the core part (i.e., bow handle 140) is covered with fiber cloth 150 and resilient and expandable polymer film 160 before applying a vacuum pressure. In this embodiment, the fiber cloth 150 is formed with multiple layers of carbon fibers, preferably with different weave patterns or layered with different alignment to other layers. The resilient film 160 was preferably made of BOPP (biaxially oriented polypropylene) or teflon.

As shown in this embodiment, the resilient film 160 should be installed in the receptacle 120 with the circumferential region 162 of the resilient film 160 extending outside from the coupled region (particularly, the seal 146) of the receptacle to provide the hermetical sealing to the inside receptacle region where the part is installed. Subsequently, by operation of a vacuum pump (not shown) connected to the installed receptacle 120, the fiber cloth 150 is closely attached onto the bow handle as the sealed polymer film 160 facilitates the vacuum generation in the inner receptacle space. FIG. 10 illustrates one sample of the resultant state in which the bow handle core is closely attached to a front face and a substantial portion of lateral sides of the bow handle by application of the vacuum pressure.

The installed receptacle 120 is then placed in a furnace (not shown) and subject to a heating environment, and the adhesive 142 is cured to cause the reinforcing cloth to firmly and permanently adhere to the core part 140. The heating temperature can range between 50° C. and 300° C., more preferably between 100° C. and 150° C., which may vary depending on the specification of the polymer film and the underlying fiber cloth.

The receptacle 120 is then taken out of the furnace, and the synthetic film 160 is peeled off from the part. A residual or unnecessary portion of the first reinforcing cloth (such as the non-adhered region outside of the first external surface where the adhesive was not applied) is cut and removed from the core part, which basically completes the first part of the inventive reinforcing method applying onto the first external surface (i.e., the upper face and a substantial portion of the upper lateral sides of the core part). FIG. 10 illustrates one example of the application.

Now, the above-described steps (namely, from the step of applying adhesive to the step of peeling off synthetic film and removing the residual fiber cloth) are repeated in connection with the second external surface of the core part 140 (i.e., the lower face and the remaining portion at the lateral sides of the core part). In this manner the first and second external surface of the bow handle 140 is securely reinforced with the composite materials, such as carbon fiber and other reinforcing materials containing fibrous or particle-like materials, for example, such as carbon fiber, fiberglass, Kevlar or aramid fiber, boron, titanium, stainless, aluminum, steel, and other reinforcement materials known in the composite material industry.

The above disclosed embodiments of the invention are representatives of a presently preferred form of the invention, but are intended to be illustrative rather than definitive thereof. Accordingly, those skilled in the art will appreciate or recognize that various modifications and substitutions can be made thereto without departing from the spirit and scope of the present invention as set forth in the appended claims. The appended claims are intended to cover, therefore, all such changes and modifications as fall within the true spirit and scope of the invention

What is claimed is:

1. A method for reinforcing an article comprising the steps of:
(a) providing a core part preformed in a shape of the article, the core part having a first external surface and a second external surface;
(b) applying adhesive on the first external surface of the core part;
(c) placing a first reinforcing cloth over the first external surface of the core part in such a manner that the reinforcing cloth is evenly distributed and conforms to the first external surface of the core part, the first reinforcing cloth containing resin and reinforcing particles or fibrous materials and having a size to cover the first external surface of the core part;
(d) placing a first synthetic film of flexible and expandable property over the first reinforcing cloth, the first synthetic film having a size to cover an entire surface of the first reinforcing cloth;
(e) hermetically sealing a circumferential area of the first synthetic film to prevent air from passing through the circumferential area of the first synthetic film;
(f) applying a vacuum pressure onto the core part covered with the first reinforcing cloth and the first synthetic film, and causing the first reinforcing cloth and the first synthetic film to closely contact and adhere to the first external surface of the core part and also to remove air bubbles entrapped or retained between the core part and the first reinforcing cloth;
(g) peeling off the first synthetic film and removing a residual or unnecessary portion of the first reinforcing cloth from the core part;
(h) applying adhesive on the second external surface of the core part;
(i) placing a second reinforcing cloth over the second external surface of the core part in such a manner that the reinforcing cloth is evenly distributed and conforms to the second external surface of the core part, the second reinforcing cloth containing resin and reinforcing particles or fibrous materials and having a size to cover the second external surface of the core part;
(j) placing a second synthetic film of flexible and expandable property over the second reinforcing cloth, the second synthetic film having a size to cover an entire surface of the second reinforcing cloth;
(k) hermetically sealing a circumferential area of the second synthetic film to prevent air from passing through the circumferential area of the second synthetic film;
(l) applying a vacuum pressure onto the core part covered with the second reinforcing cloth and the second synthetic film, and causing the second reinforcing cloth and the second synthetic film to closely contact and adhere to the second external surface of the core part and also to remove air bubbles entrapped or retained between the core part and the second reinforcing cloth; and
(m) peeling off the second synthetic film and removing a residual or unnecessary portion of the second reinforcing cloth from the core part.

2. The method of claim 1, wherein the core part is made of plastic material, aluminum, steel, wood, or composite material.

3. The method of claim 1, wherein the core part is made of urethane or composite material containing urethane.

4. The method of claim 1, wherein the adhesive is epoxy resin.

5. The method of claim 1, further comprising the steps of partially drying the adhesive, each step preformed after the respective step (b) and (g) of applying the adhesive on the core part.

6. The method of claim 1, further comprising the steps of curing the adhesive, each step performed after the respective step (f) and (l) of applying the vacuum pressure onto the core part, and thus causing the respective reinforcing cloth to securely adhere to the core part.

7. The method of claim 6, wherein the steps of curing the adhesive are performed under a heated condition.

8. The method of claim 6, wherein the steps of curing the adhesive are performed under a room temperature condition.

9. The method of claim 1, wherein the reinforcing clothes are carbon fibers.

10. The method of claim 1, wherein the reinforcing clothes contain one or more reinforcing particles or fibrous materials selected from a group consisting of carbon fiber, fiberglass, Kevlar, boron, titanium, stainless, aluminum, and steel.

11. The method of claim 10, wherein the reinforcing clothes have one or two layers.

12. The method of claim 11, further comprising the step of repeating the steps (b) to (m) until a desired layering thickness is obtained

13. The method of claim 10, wherein the reinforcing clothes have multiple layers with different weave patterns or different layering alignments to improve a mechanical strength or performance of the resultant article.

14. The method of claim 1, wherein the synthetic films are materials selected from polypropylene, BOPP (biaxially oriented polypropylene), teflon, urethane, polyethylene.

15. The method of claim 1, wherein, in said vacuum pressure application steps, said core part, covered with the first reinforcing clothes and the first synthetic film, and said core part, covered with the second reinforcing clothes and the second synthetic film, are respectively placed in a receptacle having at least one suction hole, and a vacuum pump is connected to the suction hole for applying said vacuum pressure.

16. The method of claim 15, wherein the receptacle includes a lower receptacle member having inner receptacle area, and an upper cover, the upper cover having a central through cavity and side frame portions configured to hermetically couple with the lower receptacle member, and the circumferential area of the respective synthetic film is placed in the coupling area between the lower receptacle member and the side frame portions for said hermetical sealing.

17. The method of claim 1, wherein the steps of placing the first and second synthetic films are performed under a heated condition.

18. An article reinforced with composite materials comprising:
a core part in a shape of an article and with sharp edges or corners rounded off, the core part having a first external surface forming about one half of an entire external surface of the article, the core part further having a second external surface forming about the other half of the entire external surface of the article;
a first reinforcing cloth adhered on the first external surface of the core part, the first reinforcing cloth containing resin and reinforcing particles or fibrous materials; and
a second reinforcing cloth adhered on the second external surface of the core part, the second reinforcing cloth containing resin and reinforcing particles or fibrous materials.

19. The article of claim 18, wherein the reinforcing particles or fibrous materials contained in the first and second reinforcing clothes are selected from a group consisting of carbon fiber, fiberglass, Kevlar, boron, titanium, stainless, aluminum, and steel.

20. The article of claim 19, wherein the first reinforcing cloth is adapted to have an adhesive property, and is adhered on the first external surface of the core part by covering a first synthetic film of flexible and expandable property over the first reinforcing cloth and then applying a vacuum pressure onto the covered core part, and wherein the second reinforcing cloth is adapted to have an adhesive property, and is adhered on the second external surface of the core part by covering a second synthetic film of flexible and expandable property over the second reinforcing cloth and then applying a vacuum pressure onto the covered core part.

21. A method of making a component of archery bow comprising the steps of:
(a) producing a core part in a shape of an archery bow component without having sharp edges and corners, the core part having a first or upper face surface, a second or lower face surface corresponding to the first or upper face surface, a first lateral surface, and a second lateral surface corresponding to the first lateral surface;
(b) applying adhesive on a first external surface of the core part, the first external surface covering the first or upper face surface and from about a third of the first and second lateral surfaces at an upper side of the lateral surfaces to about all of the first and second lateral surfaces;
(c) placing a first reinforcing cloth over the first external surface of the core part in such a manner that the reinforcing cloth is evenly distributed and conforms to the first external surface of the core part, the first reinforcing cloth containing resin and reinforcing particles or fibrous materials and having a size to cover the first external surface of the core part;
(d) placing a first synthetic film of flexible and expandable property over the first reinforcing cloth, the first synthetic film having a size to cover an entire surface of the first reinforcing cloth;
(e) hermetically sealing a circumferential area of the first synthetic film to prevent air from passing through the circumferential area of the first synthetic film;
(f) applying a vacuum pressure onto the core part covered with the first reinforcing cloth and the first synthetic film, and causing the first reinforcing cloth and the first synthetic film to closely contact and adhere to the first external surface of the core part and also to remove air bubbles entrapped or retained between the core part and the first reinforcing cloth;
(g) curing the adhesive applied on the first external surface of the core part under a heated condition, and thus causing the first reinforcing cloth to firmly adhere to the core part;
(h) peeling off the first synthetic film and removing a residual or unnecessary portion of the first reinforcing cloth from the core part;
(i) applying adhesive on a second external surface of the core part, the second external surface covering the second or lower face surface and from about none of the first and second lateral surfaces to about two thirds of the first and second lateral surfaces at a lower side of the lateral surfaces;
(j) placing a second reinforcing cloth over the second external surface of the core part in such a manner that the reinforcing cloth is evenly distributed and conforms to the second external surface of the core part, the second reinforcing cloth containing resin and reinforcing particles or fibrous materials and having a size to cover the second external surface of the core part;
(k) placing a second synthetic film of flexible and expandable property over the second reinforcing cloth, the second synthetic film having a size to cover an entire surface of the second reinforcing cloth;
(l) hermetically sealing a circumferential area of the second synthetic film to prevent air from passing through the circumferential area of the second synthetic film;
(m) applying a vacuum pressure onto the core part covered with the second reinforcing cloth and the second synthetic film, and causing the second reinforcing cloth and the second synthetic film to closely contact and adhere to the second external surface of the core part and also to remove air bubbles entrapped or retained between the core part and the second reinforcing cloth;
(n) curing the adhesive applied on the second external surface of the core part under a heated condition, and thus causing the second reinforcing cloth to firmly adhere to the core part; and
(o) peeling off the second synthetic film and removing a residual or unnecessary portion of the second reinforcing cloth from the core part.
